(19) United States
(12) Patent Application Publication
(10) Pub. No.: US 2017/0372311 A1
(43) Pub. Date: Dec. 28, 2017

(54) SECURE PAYMENT-PROTECTING METHOD AND RELATED ELECTRONIC DEVICE

(71) Applicant: Lenovo (Beijing) Co., Ltd., Beijing (CN)

(72) Inventor: Daliang SUN, Beijing (CN)

(21) Appl. No.: 15/469,703

(22) Filed: Mar. 27, 2017

(30) Foreign Application Priority Data
Jun. 27, 2016 (CN) 201610482197.6

(51) Int. Cl. G06Q 20/40; G06F 9/445

(52) U.S. Cl. CPC G06Q 20/401; G06F 8/61

(57) ABSTRACT

A secure payment-protecting method includes monitoring an operation status of an electronic device and, in response to determining the electronic device is in a paying state, determining whether the electronic device is in a secure environment.

### CROSS-REFERENCES TO RELATED APPLICATION

This application claims priority to Chinese Patent Application No. 201610482197.6, filed on Jun. 27, 2016, the entire contents of which are hereby incorporated by reference.

### TECHNICAL FIELD

The present disclosure generally relates to the field of secure payment and, more particularly, to a secure payment-protecting method and a related electronic device.

### BACKGROUND

Currently, more and more people use electronic devices, such as mobile phones running an Android operating system to make payments. For example, people use WeChat Pay™, Alipay™, and other methods to make payments. Conventional payment methods bring convenience to users and, at the same time, bring security risks. To ensure the security of a cell phone, a conventional solution requires a user to install a security application, and use the security application to perform antivirus scans regularly. However, in the conventional technology, a security application installed on an electronic device, such as a cell phone, is often unable to monitor the security condition of the electronic device, in real-time, causing difficulty to determine the security condition of the electronic device in a paying state. That is, the conventional methods cannot ensure the security of the cell phone during a payment process.

### SUMMARY

One aspect of the disclosure provides a secure payment-protecting method including monitoring an operation status of an electronic device and, in response to determining the electronic device is in a paying state, determining whether the electronic device is in a secure environment.

Another aspect of the disclosure provides an electronic device including a processor and a memory coupled to the processor. The memory stores instructions that, when executed by the processor, cause the processor to monitor an operation status of the electronic device and, in response to determining the electronic device is in a paying state, determine whether the electronic device is in a secure environment.

Other aspects of the present disclosure can be understood by those skilled in the art in light of the description, the claims, and the drawings of the present disclosure.

### BRIEF DESCRIPTION OF THE DRAWINGS

The drawings described below only show some embodiments of the present disclosure, and it is possible for those ordinarily skilled in the art to derive other drawings from these drawings without creative effort.

FIG. 1 illustrates a flow chart of an example of a secure payment-protecting method consistent with various disclosed embodiments of the present disclosure;

FIG. 2 illustrates a flow chart of another example of a secure payment-protecting method consistent with various disclosed embodiments of the present disclosure;

FIG. 3 illustrates a flow chart of another example of a secure payment-protecting method consistent with various disclosed embodiments of the present disclosure;

FIG. 4 illustrates a flow chart of another example of a secure payment-protecting method consistent with various disclosed embodiments of the present disclosure;

FIG. 5 illustrates a structural diagram of an example of an electronic device consistent with various disclosed embodiments of the present disclosure;

FIG. 6 illustrates a structural diagram of another example of an electronic device consistent with various disclosed embodiments of the present disclosure;

FIG. 7 illustrates a structural diagram of a processing module consistent with various disclosed embodiments of the present disclosure; and

FIG. 8 illustrates a block diagram of an electronic device consistent with various disclosed embodiments of the present disclosure.

### DETAILED DESCRIPTION

Hereinafter, embodiments consistent with the disclosure will be described with reference to the drawings. Wherever possible, the same reference numbers will be used throughout the drawings to refer to the same or like parts. The described embodiments are merely a part of, rather than all of, the embodiments of the present disclosure. On the basis of the disclosed embodiments, other embodiments obtainable by those ordinarily skilled in the art without creative effort shall fall within the scope of the present disclosure.

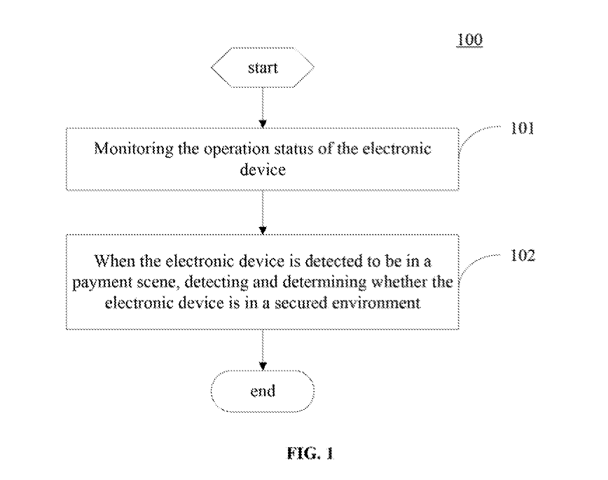

Embodiments of the present disclosure provide a secure payment-protecting method. The disclosed method may be implemented in an electronic device, such as, for example, a personal computer (PC), a laptop computer, a tablet computer, or a cell phone. FIG. 1 illustrates a flow chart of an example of secure payment-protecting method 100 consistent with the disclosure. As shown in FIG. 1, at S101, the electronic device monitors an operation status of the electronic device. At S102, when the electronic device is detected to be in a paying state, the electronic device detects and determines whether the electronic device is in a secure environment. In this disclosure, the electronic device being in a paying state refers to a situation where a user is using the electronic device to make a payment.

According to the disclosed method, the electronic device may determine whether the electronic device is in a paying state by monitoring the operation status of the electronic device. When in a paying state, the electronic device may detect and determine whether the electronic device is in a secure environment. That is, the electronic device may selectively obtain the security condition of the environment when the electronic device is in a paying state. Thus, when using a payment application installed on the electronic device, the user may be informed of the security condition of environment the electronic device is located. Thus, arrangement may be made to ensure the payment security. User experience may be improved.

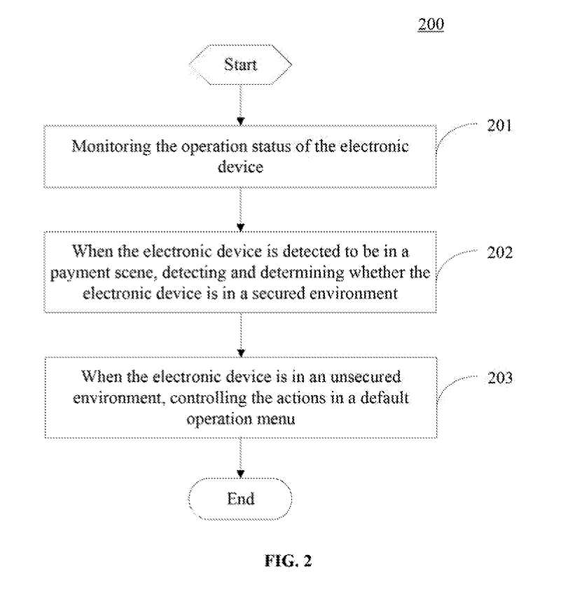

FIG. 2 illustrates a process flow of another example of secure payment-protecting method 200 consistent with the disclosure. The method 200 may be implemented in a suitable electronic device, such as a PC, a laptop computer, a tablet computer, or a cell phone.

As shown in FIG. 2, at S201, the electronic device monitors an operation status of the electronic device.

In some embodiments, monitoring the operation status of the electronic device includes monitoring the operations of the applications installed on the electronic device. When the electronic device monitors/detects a newly-started application and determines the newly-started application is a payment application through information, such as identification information, of the application, it may be determined that the electronic device is in a paying state.

At S202, when the electronic device is detected to be in a paying state, the electronic device detects and determines whether the electronic device is in a secure environment.

In some embodiments, determining whether the electronic device is in a secure environment may include detecting and determining whether the operating system platform of the electronic device, the payment application corresponding to the paying state, and/or the network to which the electronic device is connected are secure. When one or more of the operating system platform of the electronic device, the payment application corresponding to the paying state, and the network to which the electronic device is connected are not secure, it may be determined that the electronic device is in an unsecure environment.

In some embodiments, when it is detected and determined that the electronic device is in an unsecure environment, the electronic device may output an informational message indicating the electronic device is in an unsecure environment. For example, a text message, indicating the electronic device is currently in an unsecure environment, may be displayed on the current display interface of the electronic device, or a risk warning flag may be displayed at a preset location of the current display interface of the electronic device, to inform the user that the electronic device is in an unsecure environment.

When it is monitored/determined that the electronic device is in a paying state, the electronic device may check any one of the security condition of the operating system platform of the electronic device, the payment application corresponding to the paying state, and the network to which the electronic device is connected. If the checked one is determined to be unsecure, it may be determined the electronic device is in an unsecure environment.

In some embodiments, the electronic device may check the security condition of any two of the operating system platform of the electronic device, the payment application corresponding to the paying state, and the network to which the electronic device is connected. If any one of the checked two is determined to be unsecure, it may be determined the electronic device is in an unsecure environment. If both of the checked two are determined to be unsecure, it may be determined the electronic device is in an unsecure environment and the risk level may be relatively high.

In some embodiments, the electronic device may also check the security condition of all of the platform of the electronic device, the payment application corresponding to the paying state, and the network to which the electronic device is connected. If any one of them is determined to be unsecure, it may be determined the electronic device is in an unsecure environment. If any two of them are determined to be unsecure, it may be determined the electronic device is in an unsecure environment and the risk level may be relatively high. If all three of them are determined to be unsecure, it may be determined the electronic device is in an unsecure environment and the risk level may be very high.

In some embodiments, if the security condition of two or three of the platform of the electronic device, the payment application corresponding to the paying state, and the network to which the electronic device is connected are monitored and determined, the electronic device may include the risk level of the unsecure environment in the informational message used to indicate the electronic device is currently in an unsecure environment.

For example, in the scenario that the security conditions of the platform of the electronic device, the payment application corresponding to the paying state, and the network to which the electronic device is connected are all monitored and determined, if only one of them is determined to be unsecure, the informational message output by the electronic device may indicate the environment the electronic device is located is of a low risk level. If two of them are determined to be unsecure, the informational message output by the electronic device may indicate the environment the electronic device is located is of a medium risk level. If three of them are determined to be unsecure, the informational message output by the electronic device may indicate the environment the electronic device is located is of a high risk level.

In some embodiments, monitoring and determining whether the operating system platform of the electronic device is secure may include monitoring and determining whether the electronic device has been rooted. If the electronic device has been rooted, it may be determined that the operating system platform is not secure. For example, if the electronic device has been rooted, it may indicate that a criminal/hacker has obtained the system administration permissions. That is, the hacker can operate any files in the system. In this case, it is likely that the electronic device has been controlled by the hacker, who can access any information in the electronic device.

In some embodiments, monitoring and determining whether the payment application corresponding to the paying state is secure may include monitoring and determining whether signature information of the payment application has been falsified, and/or whether another process has been injected into the payment application. If the signature information of the payment application has been falsified and/or another process has been injected into the payment application, it may be determined that the electronic device is in an unsecure environment. If the signature information of the application has been falsified, it may indicate that the payment application likely has been falsified to be an unsecure payment application. If another process has been injected into the application, the injected process may likely be a dangerous data-intercepting process.

In some embodiments, monitoring and determining whether the network to which the electronic device is connected is secure may include obtaining a target network identifier of the network to which the electronic device is currently connected, and determining whether pre-stored secure network identifiers include the target network identifier. When the pre-stored secure network identifiers do not include the target network identifier, it may be determined that the network to which the electronic device is connected is unsecure. For example, some public networks, e.g., free networks at train stations, have security risks. In some embodiments, certain secure networks may be pre-stored. The pre-stored secure networks may include, e.g., the user's home network and company network. If the current network is not a pre-stored secure network, it may be determined that the network to which the electronic device is connected is unsecure.

At S203, if the electronic device is in an unsecure environment, the electronic device controls actions in a default operation menu.

For illustrated purposes, in the present disclosure, term “default” may be used to indicate any preset settings determined by the manufacturer or the user. The term “default” and “preset” may be interchangeable to indicate any settings that exist before being modified by an action described in an embodiment.

In various embodiments, the electronic device may also control the actions in the default operation menu when the electronic device is in a secure environment. The control over the actions in the default operation menu should be subjected to actual applications and should not be limited by the embodiments of the present disclosure.

In some embodiments, controlling the actions in the default operation menu may include, for example, prohibiting silent installation of an application, prohibiting data transmission to a third party irrelevant to the payment, prohibiting a write operation that writes default data to a first default location, prohibiting a read operation that reads default data from a second default location, disabling storing operations and/or debugging operations through a universal serial bus (USB), prohibiting copying operations of default data, and/or prohibiting accessing data through default information-obtaining methods.

In some embodiments, controlling the actions in the default operation menu may be implemented through, e.g., prohibiting interception of default data, prohibiting transmission of default data, and prohibiting temporary storage and transmission of default data. Because an application installed through silent installation may intercept information such as an account number and a password of the user, applications installed through silent installation may be prohibited. Further, prohibiting data transmission to a third party not relevant to the payment may prevent default data, such as the account number and password, from being sent out while ensuring the payment process is implemented normally.

Considering that information such as the account number and the password may be temporarily stored and transmitted, e.g., the account number and/or the password can be written into an SD card or copied onto a clipboard before being sent out, temporary storage of data and data transmission may be controlled. That is, the disclosed method may prohibit the write operation that writes default data to the first default location, prohibit copying of default data, prohibiting data transmission through default transmission methods such as Bluetooth.

Often, data inputted by the user, e.g., account number and password, are cached in a default location. To prevent data cached in the default location from being accessed/read and transmitted out of the electronic device, in some embodiments, the read operation that reads data from the second location may be disabled. Screen capture may be a method to obtain information. For example, information inputted by the user may be obtained through screen capture. To prevent data from being intercepted through screen capture or other similar operations, in some embodiments, operations to obtain information through default information-obtaining methods may be disabled. Further, at some public places, e.g., train stations, banks, and bus stops, charging devices may be provided. An electronic device can be connected to a charging device through a USB port for charging. However, a hacker may likely obtain information through the USB port. To prevent this from happening, in some embodiments, storing operation and/or debugging operation through USB ports may be disabled.

When the electronic device exits the payment environment, the aforementioned prohibitions can be canceled.

In various embodiments, the user may also modify certain settings in the electronic device such that the controlling of the actions in the operation menu may be flexibly adjusted by the user. For example, the user may choose to disable or prohibit certain operations/actions in the operation menu. For example, the electronic device may perform one or more of the aforementioned operations to prevent potentially unsecure activity and data transmission between the electronic device and a third party. The user may also enable one or more of the aforementioned operations if the user is aware that the enabled operations are secure.

In certain embodiments, the user may also modify certain settings in the electronic device such that the controlling of the actions in the operation menu can only be enabled manually. Thus, the user can have full control of the electronic device on when a certain action to monitor a potentially unsecure condition. For example, after the user modifies the settings in the electronic device, the aforementioned automatic control of actions in the operation menu may be disabled. Before making a payment using a payment application, the user may turn on desired actions to ensure a secure transaction environment is obtained. If the user is certain that the environment is secure, the user may also choose to not turn on any of the aforementioned actions such that the payment can be made without using extra resources in the electronic device, and the payment process may not be disturbed.

According to the secure payment-protecting method consistent with the disclosure, the electronic device may determine that the electronic device is in a paying state by monitoring the operation status of the electronic device. When determined to be in a paying state, the electronic device may detect and determine whether the electronic device is in a secure environment. When being determined to be in an unsecure environment, the electronic device may control the actions in the default operation menu to eliminate possible means that a hacker can use to obtain important data used for the paying state. Payment security can be ensured. That is, a method consistent with embodiments of the present disclosure may selectively obtain the security condition of the environment when the electronic device is in a paying state, and prevent the hacker from obtaining important data used for the paying state. Payment can be more secure and user experience may be improved.

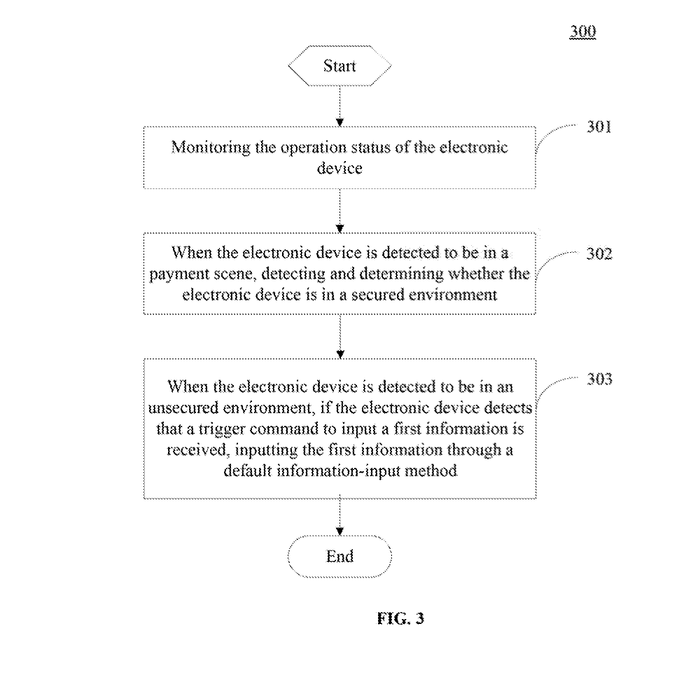

FIG. 3 illustrates a flow chart of another example of secure payment-protecting method 300 consistent with the disclosure. The method 300 may be implemented in a suitable electronic device, such as a PC, a laptop computer, a tablet computer, or a cell phone.

As shown in FIG. 3, at S301, the electronic device monitors an operation status of the electronic device.

At S302, when the electronic device is detected to be in a paying state, the electronic device monitors and determines whether the electronic device is in a secure environment.

Monitoring and determining whether the electronic device is in a secure environment when the electronic device is detected to be in a paying state are similar to those in the embodiments described above, and thus detailed description thereof is omitted.

At S303, when the electronic device is detected to be in an unsecure environment, if the electronic device detects that a trigger command to input first information is received, the electronic device inputs the first information according to a default information-input method.

The information-input method may include a first input method and a second input method. The first input method and the second input method may be different from each other.

When the electronic device is detected to be in a secure environment, if the electronic device detects that a trigger command to input the first information is received, the electronic device may also input the first information according to the default information-input method. In some embodiments, the first information may be the account number and/or password of the user to log into the payment application.

In some embodiments, inputting the first information according to the default information-input method can be realized in various manners. In one example, the electronic device may first obtain a portion of the first information from the pre-stored first information and input this portion of the first information. The electronic device may then receive the remaining portion of the first information inputted by the user. In another example, the electronic device may first receive a portion of the first information inputted by the user, and then obtain the remaining portion of the first information from the pre-stored first information. The electronic device may input the first information obtained from the user and the pre-stored first information.

In some embodiments, the first input method may include the user inputting a portion of the password into the password-input box, and the second input method may include the electronic device inputting another portion of the password into the password-input box, or vice versa.

For example, when the user is inputting the password, the electronic device may first automatically input a portion of the password in the password-input box, and then receive the remaining portion of the password typed in by the user. Alternatively, the electronic device may first receive a portion of the password typed in by the user, and then automatically input the remaining portion of the password into the password-input box.

Assuming the password is 123acgdf68, in one example, the electronic device may input 123ac into the password-input box, and the user may then type gdf68 in the password-input box. In another example, the user may type 123ac in the password-input box, and the electronic device may then automatically input gdf68 into the password-input box. In another example, the electronic device may first input 123 in the password-input box, the user may then type acgd in the password-input box, and the electronic device may then input f68 in the password-input box.

In various embodiments, the user and the electronic device may each input a portion of the first information more than once. That is, the first input method and the second input method may be used more than once to input the first information. The specific number of times and the order that the user and the electronic device input a portion of the first information can be determined according to different designs and actual application, and should not be limited by the embodiments of the present disclosure.

In conventional technology, passwords are often manually typed in by the user. Once the information, typed in manually, is intercepted, the entire password can be obtained. Consistent with embodiments of the present disclosure, two different information-input methods may be used to input important data, e.g., password, for the payment process, and it may be more difficult for a hacker to obtain the information. For example, a hacker may intercept the portion or portions of the password typed in by the user, but may not obtain the portion or portions of the password automatically inputted by the electronic device.

The secure payment-protecting method provided by the present disclosure may selectively obtain the security condition of the environment when the electronic device is in a paying state. When it is determined the electronic device is in an unsecure environment, the electronic device may use two different input methods to input information. Thus, in one aspect, the disclosed secure payment-protecting method may realize the security check on the environment when the electronic device is in a paying state, such that the user may obtain the current security condition of the electronic device. In another aspect, two different information-input methods are used to input information, making it more difficult for a hacker to obtain the information. User experience may be improved accordingly.

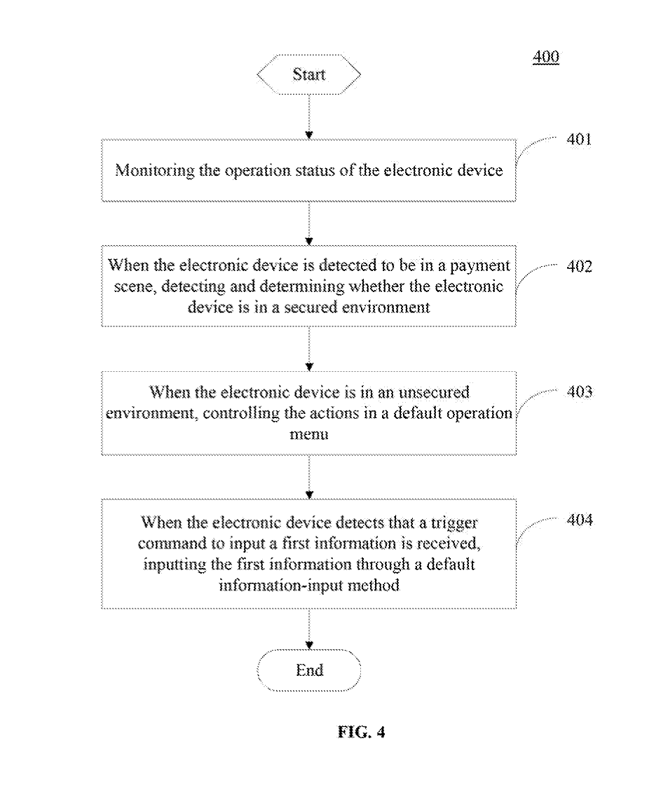

FIG. 4 illustrates a flow chart of another example of secure payment-protecting method 400 consistent with the disclosure. The method 400 may be implemented in a suitable electronic device, such as a PC, a laptop computer, a tablet computer, or a cell phone.

At S401, the electronic device monitors an operation status of the electronic device.

At S402, when the electronic device is detected to be in a paying state, the electronic device detects and determines whether the electronic device is in a secure environment.

At S403, when the electronic device is in an unsecure environment, the electronic device controls actions in a preset or default operation menu.

At S404, when the electronic device detects that a trigger command to input first information is received, the electronic device inputs the first information according to a default information-input method.

The information-input method may include a first input method and a second input method. The first input method and the second input method may be different from each other.

The details to implement processes S402-S404 can be found in the description of similar processes in aforementioned embodiments and are not repeated herein.

When the electronic device is detected to be in a secure environment, the electronic device may control the actions in the default operation menu, and/or input the first information according to the default information-input method.

The secure payment-protecting method provided by the present disclosure, may selectively obtain the security condition of the environment when the electronic device is in a paying state. When it is determined the electronic device is in an unsecure environment, the electronic device may use two different input methods to input information. Thus, in one aspect, the disclosed secure payment-protecting method may realize the security check on the environment when the electronic device is in a paying state, such that the user may obtain the current security condition of the electronic device. In another aspect, by controlling the actions in the default operation menu, possible ways that a hacker may use to obtain important data used for the paying state may be eliminated. Payment security can be ensured. In another aspect, two different input methods are used to input information. It is more difficult for a hacker to obtain the information, and user experience may be improved.

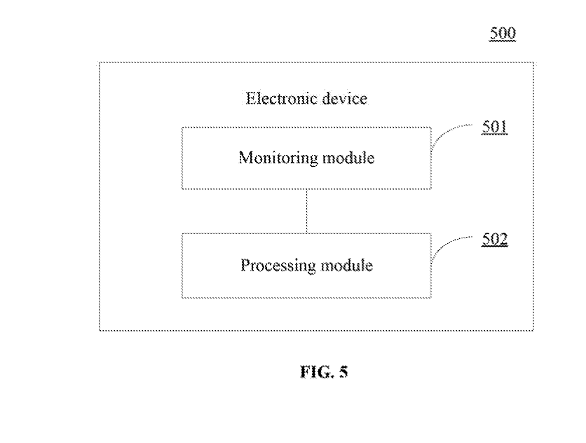

Corresponding to the disclosed secure payment-protecting method, the present disclosure further provides an electronic device. FIG. 5 illustrates a structural diagram of an example of the electronic device 500. The electronic device 500 includes a monitoring module 501 and a processing module 502.

The monitoring module 501 may monitor an operation status of the electronic device 500.

The processing module 502 may, when the electronic device 500 is detected to be in a paying state, detect and determine whether the electronic device 500 is in a secure environment.

In conventional technology, the security application installed on an electronic device is often unable to monitor the security condition of the electronic device in real-time, causing difficulty to determine the security condition of the electronic device in a paying state. The present disclosure provides an electronic device. The electronic device may determine whether the electronic device is in a paying state by monitoring the operation status of the electronic device. When in a paying state, the electronic device may detect and determine whether the electronic device is in a secure environment. That is, according to the present disclosure, the electronic device may selectively obtain the security condition of the environment when the electronic device is in a paying state. Thus, when the user is using a payment application, the user may be informed of the security condition of environment in which the electronic device is located. Thus, proper arrangement may be made to ensure the payment security. User experience may be improved.

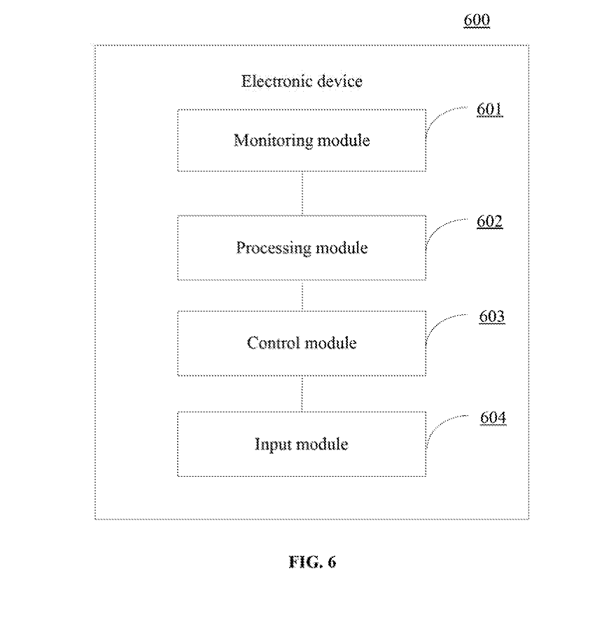

In some embodiments, the disclosed electronic device may further include a control module. FIG. 6 illustrates a block diagram of an example of the electronic device 600 including a monitoring module 601, a processing module 602, and a control module 603. The monitoring module 601 and the processing module 602 may be similar to or the same as the monitoring module 501 and the processing module 502 in the electronic device 500 shown in FIG. 5.

The control module 603 may control actions in a default operation menu.

Further, the control module may prohibit silent installation of an application, prohibit data transmission to a third party irrelevant to payment, prohibit a write operation that writes default data to a first default location, prohibit a read operation that reads default data from a second default location, disable storing operations and/or debugging operations through a universal serial bus (USB), prohibit copying operations of default data, and/or prohibit accessing data through an information-obtaining method.

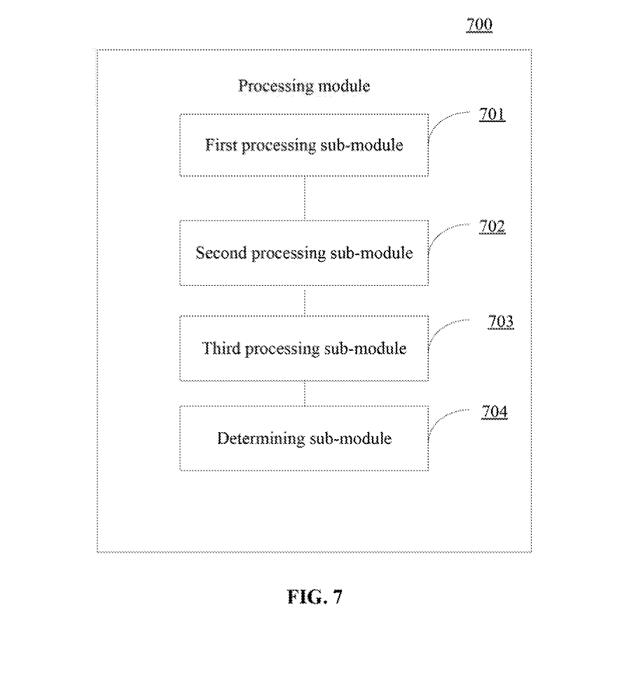

FIG. 7 illustrates a block diagram of an a processing module 700. The processing module 700 can be an example of the processing module 501 or the processing module 601 described above. As shown in FIG. 7, the processing module 700 includes a first processing sub-module 701, a second processing sub-module 702, and a third processing sub-module 703. In some embodiments, the processing module 700 also includes a determining sub-module 704. In some other embodiments, the processing module 700 may include not all, but one or some, of the above-described sub-modules.

The first processing sub-module 701 may monitor and determine whether the operating system platform of the electronic device is secure.

The second processing sub-module 702 may monitor and determine whether the payment application, corresponding to the paying state the electronic device is in, is secure.

The third processing sub-module 703 may monitor and determine whether the network to which the electronic device is connected is secure.

The determining sub-module 704 may, when one or more of the operating system platform, the payment application, and the network to which the electronic device is connected are determined to be unsecure, determine the electronic device to be in an unsecure environment.

Further, the first processing sub-module 701 may monitor and determine whether the electronic device has been rooted, and may determine the operating system platform to be unsecure if the electronic device is rooted.

Further, the second sub-processing module 702 may monitor and determine whether signature information of the payment application has been falsified, and/or another process has been injected into the payment application. When the signature information of the payment application has been falsified, and/or another process has been injected into the payment application, the second processing sub-module 702 may determine the electronic device to be in an unsecure environment.

Further, the third processing sub-module 703 may obtain a target network identifier of the network to which the electronic device is currently connected, and determine whether pre-stored secure network identifiers include the target network identifier. When the pre-stored secure network identifiers do not include the target network identifier, the third processing sub-module 703 may determine that the network to which the electronic device is connected is unsecure.

Referring again to FIG. 6, in some embodiments, the electronic device 600 further includes an input module 604.

The input module 604 may, when detecting that a trigger command to input first information is received, input the first information according to a default information-input method. The default information-input method may include a first input method and a second input method. The first input method and the second input method may be different from each other.

Further, the input module 604 may first obtain a portion of the first information from pre-stored first information, input this portion of the first information, receive the remaining portion of the first information inputted by the user. The input module 604 may also first receive a portion of the first information inputted by the user, then obtain the remaining portion of the first information from the pre-stored first information, and then input the first information obtained from the user and the pre-stored first information.

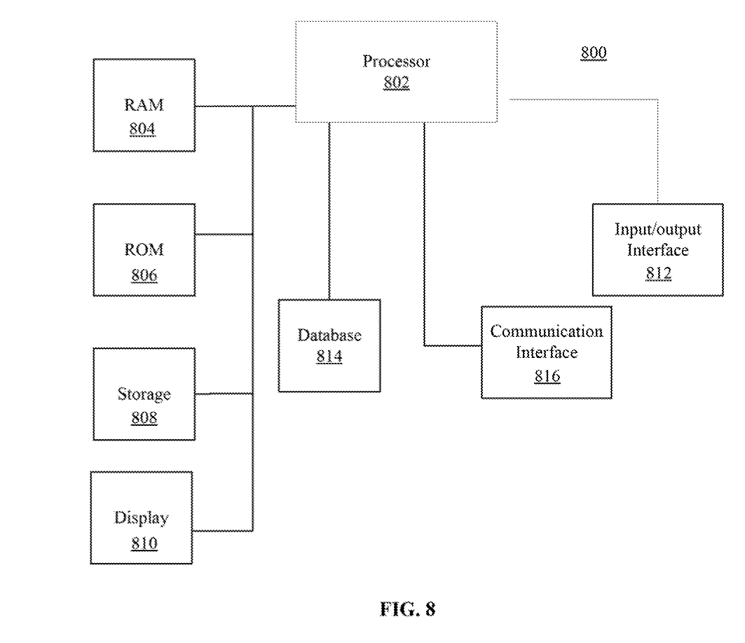

FIG. 8 illustrates a block diagram of an electronic device 800 consistent with embodiments of the present disclosure. The components illustrated in FIG. 8 may perform the functions of various modules in the electronic device 800.

The electronic device 800 may include any appropriately configured computer system. As shown in FIG. 8, the electronic device 800 includes a processor 802, a random access memory (RAM) 804, a read-only memory (ROM) 806, a storage 808, a display 810, an input/output interface 812, a database 814, and a communication interface 816. Other components may be added and certain devices may be removed without departing from the principles of the disclosed embodiments.

The processor 802 may include any appropriate type of general purpose microprocessor, digital signal processor or microcontroller, and application specific integrated circuit (ASIC). The processor 802 may execute sequences of computer program instructions to perform various processes associated with the electronic device 800, such as one of the above-described examples of secure payment-protecting method. The computer program instructions may be stored in a memory of the electronic device 800, where the memory includes one or more of the RAM 804, the ROM 806, and the storage 808. For example, the computer program instructions may be loaded into the RAM 804 for execution by the processor 802 from the ROM 806, or from the storage 808. The storage 808 may include any appropriate type of mass storage provided to store any type of information that the processor 802 may need to perform the processes. For example, the storage 808 may include one or more hard disk devices, optical disk devices, flash disks, or other storage devices to provide storage space.

The display 810 may provide information to a user or users of the electronic device 800. The display 810 may include any appropriate type of computer display device or electronic device display (e.g., CRT or LCD based devices). The input/output interface 812 may be provided for users to input information into the electronic device 800 or for the users to receive information from the electronic device 800. For example, the input/output interface 812 may include any appropriate input device, such as a keyboard, a mouse, an electronic tablet, voice communication devices, touch screens, or any other optical or wireless input devices. Further, the input/output interface 812 may receive from and/or send to other external devices.

Further, the database 814 may include any type of commercial or customized database, and may also include analysis tools for analyzing the information in the databases. The communication interface 816 may provide communication connections such that the electronic device 800 may be accessed remotely and/or communicate with other systems through computer networks or other communication networks via various communication protocols, such as transmission control protocol/internet protocol (TCP/IP), hyper text transfer protocol (HTTP), etc.

In one embodiment, the input/output interface 812 of the electronic device 800 may include or be connected to a touch pad/screen. The processor 802 may execute programs to periodically scan the operation status of the electronic device 800 such that a trigger command to input a first information or password, indicating the user is going to make a payment through an application can be timely detected. In response to the detection of the trigger command, the processor 802 may determine that the electronic device is in a paying state, and determine whether the electronic device is in a secure environment by checking the security conditions of the operating system platform of the electronic device 800, the payment application corresponding to the paying state, and the network to which the electronic device is connected 800. The security conditions of these elements may be checked through scanning the operation status of the electronic device 800. The processor 802 may obtain data reflecting the security conditions and determine whether the electronic device 800 is in an unsecure environment, and may control or prohibit certain actions in the default operation menu.

Embodiments of the present disclosure are described in a progressive manner, each of which is focused on the differences from the other embodiments, and the same similar parts between the various embodiments may be omitted from the description of some embodiments.

In the embodiments provided by the present disclosure, it should be understood that the disclosed method and device may be implemented in other manners. For example, the embodiments of the device described above are merely illustrative. The division of the units/modules is only a logical function division, and there may be other ways to divide the units/modules in actual implementation. For example, multiple units or components may be combined or integrated into another system, or some feature can be omitted or not executed. Further, the coupling, direct coupling, or communication connections shown or discussed may be an indirect coupling or a communication connection through some communication interfaces, devices and/or units. The coupling, direct coupling, or communication connection may be electrical, mechanical, or other suitable forms.

The units/modules/components described as being separated may or may not be physically separate. The units/modules/components shown as units may or may not be physical units, i.e., may be located in one place or may be distributed over a plurality of network elements. Part or all of the elements may be selected according to actual needs to achieve the object of the present disclosure. In addition, the functional units in an embodiment of the present disclosure may be integrated in one processing unit, independently present, or two or more units being integrated in one unit.

The functions can be stored in a computer-readable storage medium if these functions are implemented in the form of application functional units and sold or used as standalone products. Based on this understanding, the technical solution of the present disclosure, either essentially or in part that contributes to the prior art or part of the technical solution, may be embodied in the form of an application product stored in a storage medium. The technical solution may include several instructions to enable a computer device (which can be a personal computer, a server, or a network device, etc.) to perform all or part of the steps described in the various embodiments of the present disclosure. The aforementioned storage medium may include a variety of media capable of storing programs, such as a USB disk, a mobile hard disk, a read-only memory (ROM), a random-access memory (RAM), a magnetic disk, or an optical disk.

In the description of the embodiments, terms of “first”, “second”, and the like are only used to distinguish different objects and are not intended to suggest or indicate any differences in functions or orders.

The foregoing description of the disclosed embodiments will enable one skilled in the art to make or use the apparatus or method consistent with the present disclosure. Various modifications to these embodiments will be apparent to those skilled in the art, and the generic principles defined herein may be embodied in other embodiments without departing from the spirit or scope of the disclosure. Accordingly, the disclosure is not to be limited to the embodiments shown herein, but is to be accorded the widest scope consistent with the principles disclosed herein.

What is claimed is:

1. A secure payment-protecting method, comprising:
monitoring an operation status of an electronic device; and
in response to determining the electronic device is in a paying state, determining whether the electronic device is in a secure environment.

2. The secure payment-protecting method according to claim 1, further comprising:
in response to determining the electronic device is in an unsecure environment, controlling an action in an operation menu of the electronic device.

3. The secure payment-protecting method according to claim 2, wherein controlling the action in the operation menu includes performing one or more of:
prohibiting silent installation of an application;
prohibiting data transmission to a third party irrelevant to payment;
prohibiting a write operation that writes default data to a first default location;
prohibiting a read operation that reads the default data from a second default location;
disabling storing operations and debugging operations through a universal serial bus;
prohibiting copying operations of the default data, and
prohibiting accessing information through a default information-obtaining method.

4. The secure payment-protecting method according to claim 1, wherein determining whether the electronic device is in the secure environment includes:
determining whether one or more of an operating system platform of the electronic device, a payment application corresponding to the paying state, and a network to which the electronic device is connected are secure; and
in response to determining one or more of the operating system platform of the electronic device, the payment application corresponding to the paying state, and the network to which the electronic device is connected are not secure, determining the electronic device to be in an unsecure environment.

5. The secure payment-protecting method according to claim 4, wherein determining whether the operating system platform of the electronic device is secure includes:
determining whether the electronic device has been rooted; and
in response to determining the electronic device being rooted, determining the operating system platform to be unsecure.

6. The secure payment-protecting method according to claim 4, wherein determining whether the payment application corresponding to the paying state is secure includes:
performing one or more of a determination of whether signature information of the payment application has been falsified and a determining of whether another process has been injected into the payment application; and
in response to one of more of a determination result that the signature information of the payment application has been falsified and a determination result that another process has been injected into the payment application, determining the payment application to be unsecure.

7. The secure payment-protecting method according to claim 4, wherein determining whether the network to which the electronic device is connected is secure includes:
obtaining a target network identifier of the network to which the electronic device is connected;
determining whether pre-stored secure network identifiers include the target network identifier; and
in response to determining that the pre-stored secure network identifiers does not include the target network identifier, determining that the network to which the electronic device is connected to be unsecure.

8. The secure payment-protecting method according to claim 1, further comprising:
receiving a trigger command to input information; and
inputting the information according to an information-input method, wherein the information-input method includes a first input method and a second input method different from one another.

9. The secure payment-protecting method according to claim 8, wherein inputting the information according to the information-input method includes:
obtaining a portion of the information from pre-stored information to input to the electronic device using one of the first method and the second method; and
receiving another portion of the information input by a user to input to the electronic device using another one of the first method and the second method.

10. An electronic device, comprising:
a processor, and
a memory coupled to the processor and storing instructions that, when executed by the processor, cause the processor to:
monitor an operation status of the electronic device; and
determine, in response to determining the electronic device is in a paying state, whether the electronic device is in a secure environment.

11. The electronic device according to claim 10, wherein the instructions further cause the processor to:
control, in response to determining the electronic device is in an unsecure environment, an action in an operation menu of the electronic device.

12. The electronic device according to claim 11, wherein the instructions further cause the processor to perform one or more of:
prohibiting silent installation of an application,
prohibiting data transmission to a third party irrelevant to the paying state,
prohibiting a write operation that writes default data to a first default location,
prohibiting a read operation that reads the default data from a second default location,
disabling storing operations and debugging operations through a universal serial bus,
prohibiting copying operations of the default data, and
prohibiting accessing information through a default information-obtaining method.

13. The electronic device according to claim 10, wherein the instructions further cause the processor to:
determining whether the electronic device is in the secure environment by performing one or more of determining whether an operating system platform of the electronic device is secure, determining whether a payment application corresponding to the paying state is secure, and determining whether a network to which the electronic device is connected is secure; and
determining the electronic device to be in an unsecure environment in response to determining that one or more of the operating system platform of the electronic device, the payment application corresponding to the paying state, and the network to which the electronic device is connected are not secure.

14. The electronic device according to claim 13, wherein the instructions further cause the processor to:
determine whether the electronic device has been rooted; and
in response to determining the electronic device has been rooted, determine the operating system platform to be unsecure.

15. The electronic device according to claim 13, wherein the instructions further cause the processor to:
perform one or more of a determination of whether signature information of the payment application has been falsified and a determination of whether another process has been injected into the payment application; and
in response to one or more of a determination result that the signature information of the payment application has been falsified and a determination result that another process has been injected into the payment application, determine the electronic device to be in an unsecure environment.

16. The electronic device according to claim 13, wherein the instructions further cause the processor to:
obtain a target network identifier of the network to which the electronic device is connected;
determine whether pre-stored secure network identifiers include the target network identifier; and
in response to determining that the pre-stored secure network identifiers do not include the target network identifier, determine that the network to which the electronic device is connected to be unsecure.

17. The electronic device according to claim 10, the instructions further cause the processor to:
receive a trigger command to input information; and
input the information according to an information-input method, wherein the information-input method includes a first input method and a second input method different from one another.

18. The electronic device according to claim 17, wherein the instructions further cause the processor to:
obtain a portion of the information from pre-stored information to input to the electronic device using one of the first method and the second method; and
receive another portion of the information input by a user to input to the electronic device using another one of the first method and the second method.
